(19) United States
(12) Patent Application Publication
(10) Pub. No.: US 2021/0253941 A1
(43) Pub. Date: Aug. 19, 2021

(54) BREAKABLE POLYMERS FOR THE ASSISTED RECOVERY OF HYDROCARBONS

(71) Applicant: IFP Energies nouvelles, Rueil-Malmaison Cedex (FR)

(72) Inventors: Bruno DELFORT, RUEIL-MALMAISON CEDEX (FR); Yves BENOIT, RUEIL-MALMAISON CEDEX (FR); Veronique BARDIN, RUEIL-MALMAISON CEDEX (FR); Isabelle HENAUT, RUEIL-MALMAISON CEDEX (FR)

(21) Appl. No.: 17/254,051

(22) PCT Filed: Jun. 19, 2019
(86) PCT No.: PCT/EP2019/066255

§ 371 Date: Dec. 18, 2020

(30) Foreign Application Priority Data
Jun. 25, 2018 (FR) 1855631

(51) Int. Cl. C09K 8/588

(52) U.S. Cl. CPC C09K 8/588; C09K 2208/24

(57) ABSTRACT

The invention relates to a process for enhanced hydrocarbon recovery in a subterranean formation, in particular enhanced crude oil recovery, using at least one water-soluble terpolymer in aqueous solution, said water-soluble terpolymer being a partially hydrolysed polyacrylamide of formula (I)

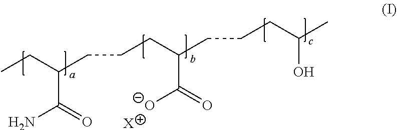

wherein X is an alkali metal cation chosen from sodium, lithium or potassium, or an ammonium cation NH₄⁺;

the coefficients a, b and c being defined in the following way:

$$\frac{a}{a + b + c}$$

is greater than or equal to 0.50, preferably between 0.5 and 0.8, limits included,

$$\frac{b}{a + b + c}$$

is less than 0.50, preferably between 0.1 and 0.4, limits included,

$$\frac{c}{a + b + c}$$

is between 0.01 and 0.20, preferably between 0.02 and 0.15, limits included, all of the ratios having a sum equal to 1.

### TECHNICAL FIELD

The present invention relates to the field of exploring for and exploiting a subterranean formation. The invention relates more particularly to the treatment of a fluid recovered from the subterranean formation. The invention relates in particular to the field of enhanced hydrocarbon recovery (or enhanced oil recovery (EOR)) and the field of production water treatment.

### PRIOR ART

For the exploration and exploitation of a subterranean formation, it is common practice to inject a fluid into the subterranean formation in order to increase the efficiency of the processes (Han D. K. & al, Recent Development of Enhanced oil Recovery in China, J. Petrol. Sci. Eng. 22(1-3): 181-188; 1999). In order to optimize these processes, it is common practice to include at least one additive in the injected fluid. This additive can take the form of a formulation of organic molecules, such as polymers, copolymers and/or surfactants, etc. This formulation can also contain inorganic molecules such as minerals (clays, barite, etc.), oxide particles (titanium oxides, iron oxides, etc.), etc. The addition of additive(s) presents certain problems linked in particular to the presence of the additive, or of molecules constituting it, in the water produced. For enhanced oil recovery in particular, it is advantageous to know whether the additive used, in general polymers, copolymers and surfactants, is in the water produced, in order to carry out an appropriate treatment of the water.

There are several enhanced oil recovery methods. When the injected fluid, also known as sweep fluid, has compounds added to it, the term tertiary enhanced recovery is used. These chemical compounds are polymers, surfactants, alkaline compounds, or mixtures of these compounds. In comparison to a simple injection of water or brine, the advantage of the presence of a polymer is to increase the viscosity of the sweep fluid and consequently to improve the mobility ratio of the injected fluid to the hydrocarbons in place in the subterranean formation.

The efficiency of recovery of hydrocarbons is increased by means of a better efficiency of the sweeping of the formation (Han D. K. & al, Recent Development of Enhanced oil Recovery in China, J. Petrol. Sci. Eng. 22(1-3): 181-188; 1999). The polymers used in this method are generally polymers of high molecular masses chosen for their viscosifying properties at moderate concentrations.

During oil production operations, water is frequently co-produced with the crude oil, a ratio of three barrels of aqueous effluent per barrel of crude oil commonly being stated.

The crude oil and the water must be separated. The oil is transported to its refining site and the water is treated so as to remove the unwanted compounds from it and so as to comply with waste standards.

Various techniques are applied for treating production water, in particular for removing dispersed drops of crude: sedimentation by gravitational separation, centrifugation, flotation with or without injection of gas, and filtration.

The use of polymers in tertiary enhanced recovery nevertheless presents practical problems. At the production wells, a production effluent is recovered which comprises a mixture of aqueous fluid and of hydrocarbons in the form of an emulsion, the water/hydrocarbon ratio of which changes as a function of the duration of production. The presence of polymer in the production effluent, due to the viscosifying effect of said polymer, makes it more difficult to separate the various fluids (oil/gas/water) and, in particular, to carry out secondary treatments of the water (Zhang Y. Q & al. Treatment of produced water from polymer flooding in oil production by the combined method of hydrolysis acidification dynamic membrane bioreactor-coagulation process, J. Petrol. Sci. Eng., 74 (1-2): 14-19, 2010). When the production effluent reaches the surface, it is treated in a surface unit. This unit makes it possible to separate the various fluids, namely gas, oil and water. At the outcome of the surface treatment, the hydrocarbons are ready to be refined. The water is treated and decontaminated in order to minimize toxic product discharges into the environment, the thresholds of which are subject to standards. The presence of the polymer in the fluids produced, as is reported in document SPE 65390 (2001) “Emulsification and stabilization of ASP Flooding Produced liquid”, can lead to the stabilization of the emulsions in the fluids produced and can present problems in terms of the surface treatment processes, in terms of the water/oil/gas separation and, in particular, in terms of the secondary water treatment processes.

While the advantage of the presence of a polymer is to increase the viscosity of the sweep water in order to improve the extraction of the hydrocarbons in place in the subterranean formation, the viscosity of the water in the production effluent becomes an obstacle to the separation between the water and the hydrocarbons.

This problem has led operators in the field to envisage means for reducing the viscosity of the produced water, that is to say of the aqueous phase in the production effluent, in order to improve the separation between the water and the hydrocarbons. Among these means, the degradation of the viscosifying polymer(s) in the produced water is envisaged and is described in the prior art.

The conventional polymers used for enhanced oil recovery (EOR) are polymers of high molar masses which generally belong to the polyacrylamide (PAM) family or the partially hydrolysed polyacrylamide (HPAM) family.

Polyacrylamides are obtained by radical polymerization of acrylamide according to the following general scheme.

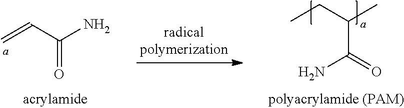

Partially hydrolysed polyacrylamides are copolymers of acrylamide with either acrylic acid or an acrylate, for example an acrylate of an alkali metal element, such as for example sodium. They can be represented for example by the following general formula in which the alkali metal element is sodium. The acrylamide monomer unit is generally predominant.

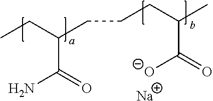

Partially hydrolysed polyacrylamides can be obtained for example by copolymerization of acrylamide with acrylic acid, the carboxylic acid function of which may optionally be neutralized to a carboxylate function of an alkali metal element such as, for example, sodium. Partially hydrolysed polyacrylamides can also be obtained by copolymerization of acrylamide with an acrylate of an alkali metal element, such as for example sodium acrylate. Partially hydrolysed polyacrylamides can also be obtained by polymerization of acrylamide to polyacrylamide, followed by partial hydrolysis of the amide functions to carboxylic acid functions or to carboxylate functions of alkali metal salts. HPAMs may be random or block copolymers.

FIG. 1 summarizes the routes for synthesis of the partially hydrolysed polyacrylamides of the prior art in the case where the alkali metal element is sodium.

The conventional polymers used in EOR are polymers of high molar masses which generally belong to the polyacrylamide (PAM) family or the partially hydrolysed polyacrylamide (HPAM) family. They may optionally contain monomer units of N-vinylpyrrolidone or acrylamido tert-butyl sulfonate (ATBS) type.

The degradation of these polymers in order to reduce or eliminate their viscosifying effect is described in particular in the document SPE-163751 “Chemical degradation of HPAM by oxidization in produced water, (2013)”, in which the HPAMs are degraded by the action of oxidizing agents such as hydrogen peroxide or sodium persulfate, or by photodegradation in the presence of titanium dioxide.

The document SPE-169719-MS “Treating back produced polymer to enable use of conventional water treatment technologies , (2014)” describes, in order to reduce the viscosity of the produced water, the degradation of HPAM polymers by the action of various oxidizing agents such as potassium persulfate, potassium percarbonate, hydrogen peroxide, sodium hypochlorite, Fenton's reagent or potassium permanganate.

The document SPE-179776-MS “Management of viscosity of the back produced viscosified water, (2016)” describes, in order to reduce the viscosity of the produced water, the degradation of HPAM polymers mechanochemically, thermally and chemically, in particular by means of chlorinated derivatives.

The means appearing in the prior art for degrading the polymer are based essentially on the use of chemical reagents, in particular oxidizing agents (Ahmadum & al; Review of technologies for oil and gas produced water management; J. Hazard Mater., 170(2-3): 530-551. 2009). The efficiency of the treatment depends essentially on the reactivity per se of these oxidizing agents, on their concentration and on the conditions under which the degradation will be carried out, in particular the reaction temperature and time. The improvements described in the prior art consist, starting from a polymer which is a conventional HPAM, in optimizing the choice and the concentration of the oxidizing agent and also the reaction conditions.

The applicant has discovered, surprisingly, that it is possible to inject an aqueous fluid containing a particular polymer as an additive which makes it possible to increase the viscosity of the fluid in order to optimize enhanced hydrocarbon recovery and that it is possible, furthermore, to reduce the viscosity of the fluid once said fluid has been reproduced at the surface in order to promote the separation between the hydrocarbons and the water, and facilitate the subsequent water treatment operations.

### DESCRIPTION OF THE INVENTION

### SUMMARY OF THE INVENTION

The invention relates to a process for enhanced hydrocarbon recovery in a subterranean formation, in particular enhanced crude oil recovery, comprising at least the following steps:

a) at least one fluid is injected into said subterranean formation, said injected fluid comprising at least one terpolymer which is water-soluble in aqueous solution, said water-soluble terpolymer being a partially hydrolysed polyacrylamide of formula (I)

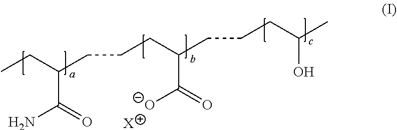

wherein X is an alkali metal cation chosen from sodium, lithium or potassium, or an ammonium cation NH₄⁺;
the coefficients a, b and c being defined in the following way:

$$\frac{a}{a + b + c}$$

is greater than or equal to 0.50, preferably between 0.5 and 0.8, limits included,

$$\frac{b}{a + b + c}$$

is less than 0.50, preferably between 0.1 and 0.4, limits included,

$$\frac{c}{a + b + c}$$

is between 0.01 and 0.20, preferably between 0.02 and 0.15, limits included, all of the ratios having a sum equal to 1;

b) at least one production effluent from said subterranean formation comprising at least one aqueous phase and one organic phase is recovered.

The process may comprise a step c) in which a reaction for chain cleavage of said water-soluble terpolymer is brought about in order to reduce the viscosity of the aqueous phase of said production effluent so as to enable the separation and/or the subsequent treatment of said aqueous phase.

Preferably, the reaction for chain cleavage of said terpolymer is brought about by oxidation by means of an oxidizing agent.

Advantageously, the oxidizing agent is chosen from: a periodate, for example a sodium, potassium or ammonium periodate, a hypochlorite, such as for example a sodium or potassium hypochlorite, a persulfate, such as for example a sodium or potassium persulfate, a peroxide, such as for example hydrogen peroxide or an organic peroxide, a permanganate, such as for example potassium permanganate, and Fenton's reagent.

It is possible to bring about the reaction for chain cleavage of said terpolymer by biodegradation.

Said biodegradation can be carried out under aerobic conditions and catalysed by alcohol oxidases or hydrolases or dehydrogenases.

Alternatively, said biodegradation can be carried out under anaerobic conditions by means of heterotrophic fermentative bacteria, of sulfate-reducing bacteria and of methanogenic bacteria.

It is possible to bring about the reaction for chain cleavage of said terpolymer by photodegradation.

In one particular embodiment, the reaction for chain cleavage of said terpolymer during step c) is brought about by oxidation by means of an oxidizing agent, coupled with biodegradation and/or photodegradation.

The process can comprise a step d) of separating the aqueous phase and the organic phase of said production effluent.

Steps c) and d) can be reversed and/or repeated.

Said terpolymer preferably consists of the linking of three monomer units derived from the following monomers:

acrylamide,
acrylic acid or acrylate of an alkali metal element, such as sodium acrylate,
and vinyl alcohol.

Said water-soluble terpolymer can be prepared by terpolymerization of acrylamide with acrylic acid and vinyl acetate, followed by a hydrolysis reaction under basic conditions.

Said water-soluble terpolymer can also be prepared by terpolymerization of acrylamide with the acrylate of an alkali metal element, for example sodium, and vinyl acetate, followed by a hydrolysis reaction under basic conditions.

Said water-soluble terpolymer can lastly be prepared by copolymerization of acrylamide with vinyl acetate, followed by a hydrolysis reaction under basic conditions.

Advantageously, the copolymerization or terpolymerization reactions are carried out in aqueous phase and initiated by one or more radical polymerization initiators such as organic peroxides or hydroperoxides, azo compounds such as 2,2′-azobis(2-methylpropionitrile), ammonium persulfates or alkali metal cation persulfates, at a temperature generally of between 20° C. and 100° C., most generally between ambient temperature and 80° C., preferably under an inert atmosphere, for a period of between 2 minutes and 12 hours.

Advantageously, the water-soluble terpolymer is isolated at the end of the copolymerization or terpolymerization reactions, and at the end of the hydrolysis step, by precipitation from an anti-solvent preferably chosen from organic solvents known to those skilled in the art, in particular acetone or methanol, so as to obtain a precipitated polymer.

In one embodiment, the precipitated polymer is then dissolved in water, then a second precipitation from an anti-solvent is carried out.

The invention also relates to the use of a water-soluble terpolymer as an additive to the injected fluid in a process for enhanced hydrocarbon recovery in a subterranean formation, in particular enhanced crude oil recovery, said water-soluble terpolymer being a partially hydrolysed polyacrylamide of formula (I)

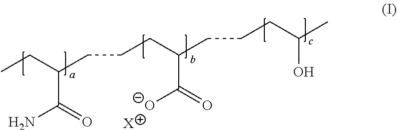

wherein X is an alkali metal cation chosen from sodium, lithium or potassium, or an ammonium cation NH₄⁺;

the coefficients a, b and c being defined in the following way:

$$\frac{a}{a + b + c}$$

is greater than or equal to 0.50, preferably between 0.5 and 0.8, limits included,

$$\frac{b}{a + b + c}$$

is less than 0.50, preferably between 0.1 and 0.4, limits included,

$$\frac{c}{a + b + c}$$

is between 0.01 and 0.20, preferably between 0.02 and 0.15, limits included, all of the ratios having a sum equal to 1.

### DETAILED DESCRIPTION OF THE INVENTION

The term “production effluent” is intended to mean in particular complex fluids comprising, alone or as a mixture, production water, hydrocarbons, drilling fluids, fracturing fluids, water from geological formations, etc.

The present invention relates to the use of a family of viscosifying polymers for enhanced oil recovery, said polymers being particularly suitable for being more sensitive to degradation, in particular under the action of oxidizing agents, than the polymers conventionally used in EOR, such as HPAMs. The greater sensitivity of these polymers to the action of oxidizing agents makes it possible, by better degradation, to obtain a better reduction of the viscosity of the aqueous phase of the production effluent which contains them. It may also make it possible to obtain this reduction in viscosity more rapidly and/or under milder conditions.

### LIST OF THE FIGURES

FIG. 1 presents the scheme of the routes for synthesis of partially hydrolysed polyacrylamides of the prior art.

FIG. 2 presents the chemical formula (I) of the terpolymers used in the process according to the invention, with X═Na.

FIG. 3 presents the scheme of three routes of synthesis for the partially hydrolysed polyacrylamides which contain at least one monomer unit of vinyl alcohol type, and which are used in the process according to the invention.

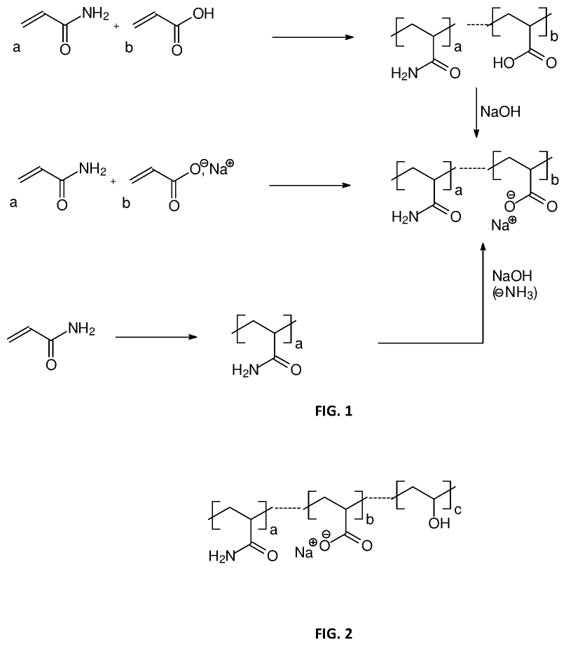

The figures illustrate the invention in a non-limiting manner.

The terpolymers present in the injected fluid in the enhanced recovery process according to the invention are partially hydrolysed polyacrylamides which contain at least one monomer unit of vinyl alcohol type. Said terpolymers comprise the linking of three monomer units derived from the following monomers: 1) acrylamide, 2) acrylic acid or acrylate of an alkali metal element, such as for example sodium acrylate, and 3) vinyl alcohol. The distribution of these monomer units along the polymer chain may be random or in blocks. Said terpolymers can be represented by the following general formula (I) in which the element X is an alkali metal cation, chosen from the cations of alkali metal elements such as sodium, lithium or potassium, preferably sodium (see FIG. 2). The alkali metal element can optionally be replaced with an ammonium cation NH₄⁺.

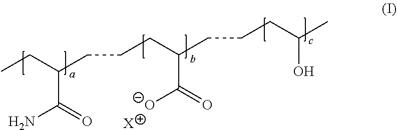

In general formula (I), the coefficients a, b and c are defined in the following way:

$$\frac{a}{a + b + c}$$

is greater than or equal to 0.50, preferably between 0.5 and 0.8, limits included,

$$\frac{b}{a + b + c}$$

is less than 0.01 and 0.20, preferably between 0.1 and 0.4, limits included,

$$\frac{c}{a + b + c}$$

is between 0.01 and 0.20, preferably between 0.02 and 0.15, limits included, all of the ratios having a sum equal to 1.

Surprisingly, the applicant has discovered that the presence of at least one monomer unit of vinyl alcohol type within the chain of such a polymer increases the sensitivity of the polymer chain to breaking, in particular under the action of oxidizing reagents. Thus, it is possible, under the action of oxidizing reagents, and generally under conditions that are milder than in the prior art, to break the polymer chain into two or more segments, which makes it possible to reduce the molar mass of the polymer and thus to decrease its viscosifying power.

The presence of monomer units of vinyl alcohol type inserted into the polymer chain of the partially hydrolysed polyacrylamide as described above makes in particular said polymer cleavable under conditions where a conventional HPAM partially hydrolysed polyacrylamide would not be breakable or, in any event, would be less breakable.

### Preparation of the Terpolymers that can be Used in the EOR Process According to the Invention

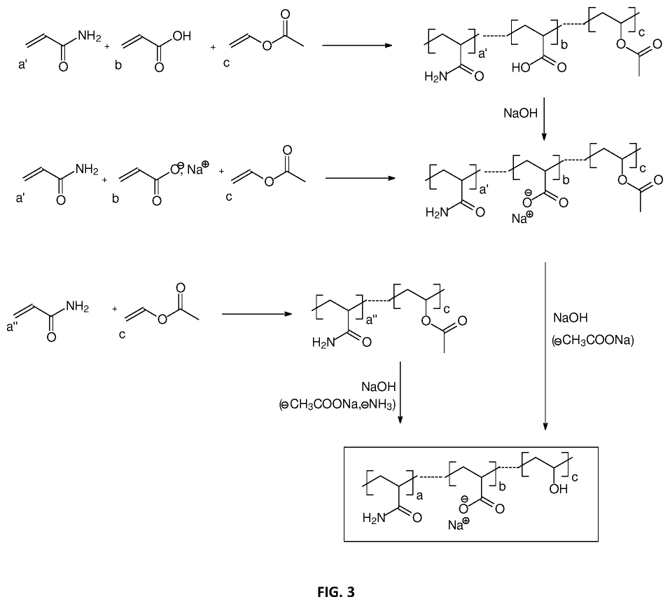

The synthesis of the terpolymers of the invention can advantageously be carried out according to three routes described below (see FIG. 3).

In a first embodiment, the terpolymer used in the invention is prepared by radical terpolymerization of acrylamide with acrylic acid and vinyl acetate, the terpolymerization reaction being followed by a hydrolysis reaction under basic conditions, for example in the presence of sodium hydroxide, which hydrolyses the ester function provided by the vinyl acetate monomer unit to an alcohol function and simultaneously neutralizes the carboxylic acid function present in the acrylic acid monomer unit, to give a carboxylate, for example sodium carboxylate, function. The hydrolysis reaction can also affect the amide functions provided by the acrylamide monomer unit, to give carboxylate functions. The latter reaction can be limited by carrying it out under moderate hydrolysis conditions, in particular by carrying it out at moderate temperatures, for example at ambient temperature, given the greater stability of the amide functions with respect to hydrolysis compared with the ester functions.

In a second embodiment, the terpolymer used in the invention is prepared by radical terpolymerization of acrylamide with the acrylate of an alkali metal element, for example sodium, and vinyl acetate, the terpolymerization reaction being followed by a hydrolysis reaction under basic conditions, for example in the presence of sodium hydroxide, which hydrolyses the ester function provided by the vinyl acetate monomer unit to an alcohol function. The hydrolysis reaction can also affect the amide functions provided by the acrylamide monomer unit, to give carboxylate functions. The latter reaction can be limited by carrying it out under moderate hydrolysis conditions, given the greater stability of the amide functions with respect to hydrolysis compared with the ester functions.

In a third embodiment, the terpolymer used in the invention is prepared by radical copolymerization of acrylamide with vinyl acetate, the copolymerization reaction being followed by a hydrolysis reaction under basic conditions, for example in the presence of a base such as sodium hydroxide, which hydrolyses the ester functions provided by the vinyl acetate monomer unit to an alcohol function. In this case, the base hydrolyses, during the same step, the amide functions provided by the acrylamide monomer unit to carboxylate functions.

The three synthesis routes can be represented by the scheme of FIG. 3 in which the base is sodium hydroxide and the alkali metal element X is sodium Na, but it may be any other alkali metal element, such as for example lithium or potassium. The alkali metal element can optionally be replaced with the ammonium cation NH₄⁺.

### Operating Conditions

### Polymerization

The polymerization, copolymerization or terpolymerization reactions are generally carried out in water. The reactions are initiated by one or more radical polymerization initiators belonging to well-known chemical families, such as for example organic peroxides or hydroperoxides, azo compounds such as 2,2′-azobis(2-methylpropionitrile), ammonium persulfates or alkali metal cation persulfates.

The polymerization reactions are carried out at a temperature generally of between 20° C. and 100° C., most generally between ambient temperature and 80° C.

The polymerization reactions are preferably carried out under an inert atmosphere.

The polymerization time is generally between a few minutes and a few hours, preferably between 2 minutes and 12 hours, preferably between 1 and 6 hours, very preferably between 30 minutes and 4 hours.

The monomers are preferably dissolved in an aqueous solution, in the proportions which make it possible to obtain the desired ratios between the indices a, b and c. The solution can be degassed beforehand with argon in order to obtain an inert atmosphere. The radicalization initiator chosen is then introduced in proportions known to those skilled in the art for initiating polymerization. The mixture is optionally heated so as to obtain a temperature above ambient temperature, and optionally subjected to stirring. The mixture is advantageously cooled to ambient temperature. The polymer obtained is isolated by precipitation from the anti-solvent. The polymer is advantageously washed, preferably washed with the same anti-solvent, then advantageously dried at a temperature of between 20° C. and 100° C. for a period of between 1 and 24 h.

### Hydrolysis Under Basic Conditions

The dried polymer is dissolved in an alkaline aqueous solution, preferably water containing sodium hydroxide, in such a way that the pH of the solution is strictly above 7, advantageously above 9, preferably above 11, very preferably between 12.0 and 13.5, even more preferably between 12.5 and 13.0. The medium is advantageously degassed with argon so as to be operating in an inert atmosphere, then stirred at ambient temperature for a period of between 1 and 48 hours, preferably between 2 and 36 hours, very preferably between 12 and 24 hours. The pH of the solution is then advantageously strictly above 7, very preferably above 8, even more preferably between 9 and 11. The partially hydrolysed polymer obtained is isolated by precipitation from the anti-solvent. The polymer is advantageously washed, preferably washed with the same anti-solvent, then advantageously dried at a temperature of between 20° C. and 100° C. for a period of between 1 and 24 h.

The hydrolysis reaction is carried out under basic conditions by dissolving the polymer obtained in the presence of a basic compound, such as sodium hydroxide. The pH of the mixture is strictly above 7, preferably above 9, very preferably above 11, and even more preferably between 11.5 and 13.5, very advantageously between 12.0 and 13.5, limits included.

At the end of each of the polymerization and hydrolysis steps, the polymer obtained is isolated, usually by precipitation from an anti-solvent which is preferably chosen from organic solvents known to those skilled in the art, in particular acetone or methanol. This precipitation operation can be optionally repeated after precipitation of the obtained polymer from the anti-solvent; the precipitated polymer is dissolved in water, then a second precipitation from an anti-solvent is carried out.

After precipitation, the polymer is advantageously washed, preferably washed with the same anti-solvent, then dried at a temperature of between 20° C. and 100° C. for a period advantageously of between 1 and 24 h.

The nitrogen to carbon, N/C, mass ratio of the water-soluble terpolymer obtained is advantageously between 0.1 and 0.5, preferably between 0.2 and 0.4.

### Enhanced Hydrocarbon Recovery Process According to the Invention

Following the injection of a fluid into the subterranean formation in accordance with the process according to the invention, when the production effluent is recovered at the surface, the separation of the production water and of the polymer is facilitated by a treatment which makes it possible to cleave the chain of the water-soluble terpolymer described above.

In one preferred embodiment, the reaction for chain cleavage of the polymer of the invention can be brought about by the action of an oxidizing agent known to break covalent bonds between two carbon atoms, such as for example, without being limiting:
a periodate, for example sodium, potassium or ammonium periodate
a hypochlorite, such as for example a sodium or potassium hypochlorite
a persulfate, such as for example a sodium or potassium persulfate
a peroxide, such as for example hydrogen peroxide or an organic peroxide
a permanganate, such as for example potassium permanganate
Fenton's reagent.

In another embodiment, the reaction for chain cleavage of the polymer of the invention can be advantageously carried out by biodegradation. The biodegradation can be carried out under aerobic conditions and catalysed by alcohol oxidases or hydrolases responsible for endo-type cleavages. Via this biodegradation route, the ultimate reaction product is CO₂. It can be catalysed by dehydrogenases, which result in the formation of intermediates of the poly(vinyl)ketone type, subsequently cleaved by hydrolases to give, as final biodegradation product, methyl ketones or carboxylates.

The biodegradation can be carried out under anaerobic conditions, through the synergistic action of bacterial consortia composed of heterotrophic fermentative bacteria, sulfate-reducing bacteria and methanogenic bacteria. This degradation chain results in the production of acetate, of CH₄ and of CO₂. At the industrial level, these operations can be envisaged in anaerobic digesters. In the two cases, these biodegradations result in oligomers of lower masses and induce significant drops in viscosity.

In yet another embodiment, the reaction for chain cleavage of the polymer of the invention can be carried out by photodegradation. This involves the breaking of covalent bonds under the action of photons, for example by subjecting the solution of polymer to ultraviolet radiation, or the breaking of bonds following ionization, for example caused by subjecting the sample to accelerated-electron radiation.

In one preferred embodiment, it is advantageous to couple the degradation of the polymer under the effect of a chemical reagent, such as an oxidizing agent, to biodegradation and/or to photodegradation.

The process according to the invention may comprise at least one step d) of separating the aqueous phase and the organic phase of said production effluent, before or after the treatment step making it possible to cleave the chain of the water-soluble terpolymer described above, preferably before.

The aqueous phase can then be subjected to any type of conventional secondary water treatment as described above.

### EXAMPLES

### Example 1: synthesis of an HPAM-Co-Vinyl Alcohol Terpolymer According to the Invention

55 mg of ammonium persulfate are introduced into a solution of 6.4 g (0.090 mol) of acrylamide, of 1.6 g (0.017 mol) of sodium acrylate and of 1.89 g (0.022 mol) of vinyl acetate in 250 g of water, previously degassed with argon, then the medium is brought to 60° C. with stirring for 5 hours. After a return to ambient temperature, the polymer formed is isolated by precipitation from 1.2 l of acetone. After washing with 500 ml of acetone, the polymer is dried at 50° C. for 5 hours. 5.05 g of an off-white solid are obtained.

2.5 g of the solid obtained are dissolved in 50 g of water containing 0.444 g (0.011 mol) of sodium hydroxide. The pH of the solution is between 12.5 and 13.0. The medium is degassed with argon, then stirred at ambient temperature for 24 hours. The pH is then 9.5. The polymer formed is isolated by precipitation from 0.6 l of methanol. After washing with 400 ml of methanol, the polymer is dried at 50° C. for 3.5 hours. 1.4 g of an off-white solid are obtained. The elemental analysis of the polymer indicates an N/C mass ratio equal to 0.232.

### Example 2: Synthesis of an HPAM-Co-Vinyl Alcohol Terpolymer According to the Invention

27 mg of ammonium persulfate are introduced into a solution of 3.6 g (0.051 mol) of acrylamide, of 0.90 g (0.0096 mol) of sodium acrylate and of 1.00 g (0.012 mol) of vinyl acetate in 100 g of water, previously degassed with argon, then the medium is brought to 60° C. with stirring for 5 hours. After a return to ambient temperature, 0.93 g (0.023 mol) of sodium hydroxide is introduced. The pH of the solution is between 12.5 and 13.0. The medium is degassed with argon, then stirred at ambient temperature for 24 hours. The pH is then 9.5. The polymer formed is isolated by precipitation from 0.5 I of methanol. After washing with 400 ml of methanol, the polymer is dried at 50° C. for 4 hours. 4.6 g of an off-white solid are obtained. The elemental analysis of the polymer indicates an N/C mass ratio equal to 0.25.

### Example 3: Synthesis of an HPAM-Co-Vinyl Alcohol Terpolymer According to the Invention

24 mg of ammonium persulfate are introduced into a solution of 3.6 g (0.051 mol) of acrylamide and of 0.50 g (0.0058 mol) of vinyl acetate in 100 g of water, previously degassed with argon, then the medium is brought to 60° C. with stirring for 5 hours. After a return to ambient temperature, 0.93 g (0.023 mol) of sodium hydroxide is introduced. The pH of the solution is 12.5. The medium is degassed with argon, then stirred at ambient temperature for 24 hours. The pH is then 9.5. The polymer formed is isolated by precipitation from 1.0 l of methanol. After washing with 400 ml of methanol, the polymer is dried at 50° C. for 4 hours. 3.3 g of an off-white solid are obtained. The elemental analysis of the polymer indicates an N/C mass ratio equal to 0.28.

### Example 4 (Comparative): Synthesis of a Polyacrylamide

60 mg of ammonium persulfate are introduced into a solution of 10.0 g (0.14 mol) of acrylamide in 250 g of water, previously degassed with argon, then the medium is brought to 60° C. with stirring for 5 hours. After a return to ambient temperature, the polymer formed is isolated by precipitation from 1.8 l of acetone. After washing with 500 ml of acetone, the polymer is dried at 50° C. for 5 hours. 9.1 g of an off-white solid are obtained. The elemental analysis of the polymer indicates an N/C mass ratio equal to 0.38.

### Example 5 (Comparative): Synthesis of an HPAM Copolymer

27 mg of ammonium persulfate are introduced into a solution of 4.2 g (0.059 mol) of acrylamide and of 0.80 g (0.0085 mol) of sodium acrylate in 260 g of water, previously degassed with argon, then the medium is brought to 60° C. with stirring for 5 hours. After a return to ambient temperature, the polymer formed is isolated by precipitation from 1.4 l of acetone. After washing with 500 ml of acetone, the polymer is dried at 50° C. for 5 hours. 3.1 g of an off-white solid are obtained. The elemental analysis of the polymer indicates an N/C mass ratio equal to 0.35.

### Example 6: Oxidizing Degradation Tests

Each polymer resulting from Examples 1 to 3 (according to the invention) and from (comparative) Examples 4 and 5 is dissolved in water in order to obtain 40 g of solution of polymers at a concentration of 1.00% by mass, except for the polymer resulting from Example 1, for which the concentration is 0.21% by mass. Each solution is divided into two fractions, each of 20 g. 100 mg of sodium sulfite are introduced into each first fraction constituting the reference sample without oxidation, except for the polymer resulting from Example 1 for which the amount of sodium sulfite is 25 mg, then the medium is degassed with argon and the sample is stored in the absence of air, as reference sample.

145 mg of sodium periodate are introduced into each second fraction constituting the test sample, then the medium is stirred in the presence of air for 5 hours at 50° C. After a return to ambient temperature, 100 mg of sodium sulfite are introduced into each second fraction, except for the polymer resulting from Example 1 for which the amount of sodium sulfite is 25 mg, then the medium is degassed with argon and the sample is stored in the absence of air, as test sample. The sodium sulfite added makes it possible to stabilize the samples until the analysis.

A viscosity measurement is carried out on each sample (reference and test) for each example, using a rotational rheometer (DHR3 from TA Instruments). A double cylinder type geometry is used. A logarithmic flow sweep is carried out at between 1 and 200 s⁻¹. The values are measured at 10 s⁻¹. The following table makes it possible to compare the viscosities obtained from one and the same solution of each polymer before oxidation (reference, V1) and after oxidation (test, V2). It is clearly apparent that the viscosifying power after oxidation of the polymers according to the invention resulting from Examples 1, 2 and 3 is much more affected than that of the conventional polymers of PAM or HPAM type resulting from Examples 4 and 5. The V2/V1 ratio illustrates the sensitivity of the reduction in viscosity.

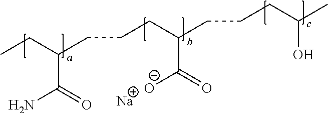

| | | | | | Viscosity | | |
|---|---|---|---|---|---|---|---|
| | | | | Concentration | (Cp) | | |
| Polymer of | | | | in water | V1: before | V2: after | V2/V1 |
| Example | a | b | c | % by mass | oxidation | oxidation | (%) |
| 1 | 0.58 | 0.34 | 0.08 | 0.21 | 7.1 | 1.0 | 0.14 |
| 2 | 0.62 | 0.30 | 0.08 | 1.00 | 18.0 | 1.3 | 0.07 |
| 3 | 0.6 | 0.31 | 0.09 | 1.00 | 23.3 | 1.4 | 0.06 |
| 4 | 1.00 | 0 | 0 | 1.00 | 5.4 | 1.9 | 0.35 |
| 5 | 0.905 | 0.095 | 0 | 1.00 | 6.3 | 1.8 | 0.29 |

1. Process for enhanced hydrocarbon recovery in a subterranean formation, in particular enhanced crude oil recovery, comprising at least the following steps:
a) at least one fluid is injected into said subterranean formation, said injected fluid comprising at least one terpolymer which is water-soluble in aqueous solution, said water-soluble terpolymer being a partially hydrolysed polyacrylamide of formula (I) 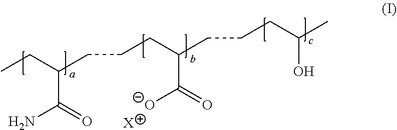
wherein X is an alkali metal cation chosen from sodium, lithium or potassium, or an ammonium cation NH₄⁺;
the coefficients a, b and c being defined in the following way:
$$\frac{a}{a + b + c}$$
is greater than or equal to 0.50, preferably between 0.5 and 0.8, limits included,
$$\frac{b}{a + b + c}$$
is less than 0.50, preferably between 0.1 and 0.4, limits included,
$$\frac{c}{a + b + c}$$
is between 0.01 and 0.20, preferably between 0.02 and 0.15, limits included, all of the ratios having a sum equal to 1;
b) at least one production effluent from said subterranean formation comprising at least one aqueous phase and one organic phase is recovered.

2. Process according to claim 1, comprising a step c) in which a reaction for chain cleavage of said water-soluble terpolymer is brought about in order to reduce the viscosity of the aqueous phase of said production effluent so as to enable the separation and/or the subsequent treatment of said aqueous phase.

3. Process for enhanced hydrocarbon recovery according to claim 2, in which the reaction for chain cleavage of said terpolymer is brought about by oxidation by means of an oxidizing agent.

4. Process according to claim 3, in which the oxidizing agent is chosen from: a periodate, for example a sodium, potassium or ammonium periodate, a hypochlorite, such as for example a sodium or potassium hypochlorite, a persulfate, such as for example a sodium or potassium persulfate, a peroxide, such as for example hydrogen peroxide or an organic peroxide, a permanganate, such as for example potassium permanganate, and Fenton's reagent.

5. Process according to claim 2, in which the reaction for chain cleavage of said terpolymer is brought about by biodegradation.

6. Process according to claim 5, in which said biodegradation is carried out under aerobic conditions and catalysed by alcohol oxidases or hydrolases or dehydrogenases.

7. Process according to claim 5, in which said biodegradation is carried out under anaerobic conditions by means of heterotrophic fermentative bacteria, sulfate-reducing bacteria and methanogenic bacteria.

8. Process according to claim 2, in which the reaction for chain cleavage of said terpolymer is brought about by photodegradation.

9. Process according to claim 2, in which the reaction for chain cleavage of said terpolymer during step c) is brought about by oxidation by means of an oxidizing agent, coupled with biodegradation and/or photodegradation.

10. Process according to claim 1, one of the preceding claims, comprising a step d) of separating the aqueous phase and the organic phase of said production effluent.

11. Process according to claim 2, in which steps c) and d) are reversed and/or repeated.

12. Process according to claim 1, in which said terpolymer consists of the linking of three monomer units derived from the following monomers: acrylamide, acrylic acid or acrylate of an alkali metal element, such as sodium acrylate, and vinyl alcohol.

13. Process according to claim 1, in which said water-soluble terpolymer is prepared by terpolymerization of acrylamide with acrylic acid and vinyl acetate, followed by a hydrolysis reaction under basic conditions.

14. Process according to claim 1, in which said water-soluble terpolymer is prepared by terpolymerization of acrylamide with the acrylate of an alkali metal element, for example sodium, and vinyl acetate, followed by a hydrolysis reaction under basic conditions.

15. Process according to claim 1, in which said water-soluble terpolymer is prepared by copolymerization of acrylamide with vinyl acetate, followed by a hydrolysis reaction under basic conditions.

16. Process according to claim 13, in which the copolymerization or terpolymerization reactions are carried out in aqueous phase and initiated by one or more radical polymerization initiators such as organic peroxides or hydroperoxides, azo compounds such as 2,2′-azobis(2-methylpropionitrile), ammonium persulfates or alkali metal cation persulfates, at a temperature generally of between 20° C. and 100° C., most generally between ambient temperature and 80° C., preferably under an inert atmosphere, for a period of between 2 minutes and 12 hours.

17. Process according to claim 13, in which the water-soluble terpolymer is isolated at the end of the copolymerization or terpolymerization reactions, and at the end of the hydrolysis step, by precipitation from an anti-solvent preferably chosen from organic solvents known to those skilled in the art, in particular acetone or methanol, so as to obtain a precipitated polymer.

18. Process according to claim 17, in which the precipitated polymer is dissolved in water, then a second precipitation from an anti-solvent is carried out.

19. Use of a water-soluble terpolymer as an additive to the injected fluid in a process for enhanced hydrocarbon oil recovery in a subterranean formation, in particular enhanced crude oil recovery, said water-soluble terpolymer being a partially hydrolysed polyacrylamide of formula (I) 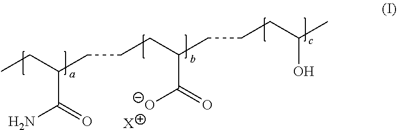
wherein X is an alkali metal cation chosen from sodium, lithium or potassium, or an ammonium cation NH₄⁺;
the coefficients a, b and c being defined in the following way:
$$\frac{a}{a + b + c}$$
is greater than or equal to 0.50, preferably between 0.5 and 0.8, limits included,
$$\frac{b}{a + b + c}$$
is less than 0.50, preferably between 0.1 and 0.4, limits included,
$$\frac{c}{a + b + c}$$
is between 0.01 and 0.20, preferably between 0.02 and 0.15, limits included, all of the ratios having a sum equal to 1.
